(19) United States
(12) Patent Application Publication
(10) Pub. No.: US 2004/0238297 A1
(43) Pub. Date: Dec. 2, 2004

(54) Brake shoe, especially for a disc brake

(76) Inventors: Joerg Brecht, Odenthal (DE); Achim Dohle, Leverkusen (DE); Wolfgang Hoffrichter, Koeln (DE)

Correspondence Address: Diller Ramik & Wight, Merrion Square, Suite 101, 7345 McWhorter Place, Annandale, VA, 22003, US

(21) Appl. No.: 10/483,062

(22) PCT Filed: Jul. 6, 2002
(86) PCT No.: PCT/EP02/07552

(30) Foreign Application Priority Data
Jul. 13, 2001 (DE) 101 34 067.2

(51) Int. Cl. F16D 65/38

(52) U.S. Cl. 188/73.37

(57) ABSTRACT

In a brake shoe, in particular for a disk brake of motor vehicles, comprising a support plate (2) to which a friction lining (6) is fastened, the carrier plate (2) is formed by a plurality of interconnected or separate plate portions (8,10;12, 14), wherein at least one plate portion (8) carries the friction lining (6) which, relative to the at least one further plate portion (10;12,14), is elastically or viscoelastically supported to prevent friction oscillations from occurring during the braking process.

The invention relates to a brake shoe according to the precharacterizing part of claim 1.

Such brake shoes are in particular suitable for disk brakes in motor vehicles and comprise a support plate made of metal to which a friction lining is fastened preferably by gluing. Between the friction lining and the support plate an intermediate layer may be arranged which on the one hand acts as an oscillation damper and on the other hand glues the friction lining to the support plate.

During a braking process oscillations occur in the overall system, said oscillations being produced by interacting brake system elements, e.g. the brake shoes, the brake disk and the brake shoe guide, and possibly leading to undesired noise and vibrations.

For damping said oscillations, it is common practice to glue a damping plate to the rear side of a support plate.

From DE 44 35 669 A it is further known that a damping means in the form of a slot is provided on the support plate side edges resting against the brake shoe guides.

In known brake shoes undesired concomitant phenomena occur during the braking process, said phenomena depending upon the wear condition of the brake shoes. For example, it is known that the brake shoes, with increasing wear, contribute to an increasing braking noise formation since the friction linings, with increasing age, become harder and less compressible due to thermal stress. Thus, the friction linings are less capable of conforming to the brake shoes whose geometry may change under the influence of heat.

The noise can be characterized as follows:

Crushing (broad-band noise: 200 Hz to 8 kHz),

Squeaking (1500 Hz to 15 kHz),

Rubbing (20 Hz to 100 Hz),

Humming (20 Hz to 600 Hz), and

Wire-brush noise.

Rubbing effects such as oscillations occurring when the steering wheel is turned and pulsation of the brake pedal, as well as humming may grow with increasing wear.

It is an object of the invention to provide a brake shoe by means of which noise development and transmission of oscillations to other vehicle elements can be reduced.

This object is achieved with the features of claim 1.

According to the invention, the support plate is preferably formed by a plurality of interconnected or separate plate portions with at least one plate portion carrying the friction lining which is, relative to the at least one further plate portion, elastically or viscoelastically supported thereby preventing friction oscillations from occurring during the braking process.

According to the invention, the support plate is thus formed by a plurality of plate portions which are elastically or viscoelastically connected with each other. In this manner, the oscillations induced in the plate portion carrying the friction lining are strongly damped before they are transmitted to the other plate portion which is coupled to the guiding elements of the brake. The invention allows for decoupling of the tangential and axial friction forces and their low-frequency and high-frequency variations, which results in a low noise and vibration development.

The invention allows for the use of friction linings with a low stiffness and high damping properties towards the friction forces without the drawback of an excessive compressibility in the pressure direction of the brake piston.

Preferably, the support plate is formed by two plate portions which are elastically or viscoelastically connected with each other. An inner plate portion may by surrounded by an outer plate portion. The friction lining is preferably fastened to the inner plate portion, wherein the plate portions are separated from each other by a circumferential slot.

In one embodiment, at least one connecting web may be provided in the slot, said connecting web connecting the plate portions with each other. In this case the inner and the outer plate portion are formed by an integral support plate.

The at least one connecting web may further be arranged on the radial centerline of the support plate or on a central tangential line of the support plate. The arrangement of the connecting webs influences the stiffness of the support plate in tangential and radial direction, respectively, wherein the arrangement of two connecting webs on the radial centreline of the support plate is preferred. The orientation of the connecting webs has an effect on the damping and oscillating behaviour in radial and tangential direction, wherein the connecting webs elastically connect the plate portions with each other.

In one embodiment, the friction lining is exclusively connected with the inner plate portion. In this embodiment, the friction lining cannot transmit any oscillations directly to the outer plate portion.

In an alternative embodiment, the friction lining is connected with both plate portions thus covering the slot or gap between the two plate portions.

It may further be envisaged that the inner and the outer plate portion are elastically or viscoelastically connected with each other exclusively via the friction lining.

In a preferred embodiment, the plate portion carrying the friction lining is connected with the at least one further plate portion via an elastic intermediate element. Said intermediate element is arranged in the gap or slot between the two plate portions and allows for high damping of the oscillations accepted or generated via the friction lining.

The intermediate element can be made of an elastomeric material, of the friction material proper or of an intermediate layer material. When the intermediate element is made of friction material or intermediate layer material, it can be pressed into the interspace between the two plate portions when the friction lining is pressed on.

In a further alternative embodiment, the intermediate element is formed by at least one metallic spring element.

Preferably, the inner plate portion is separated from the outer plate portion by a circumferential slot. Said slot is configured as a continuous slot with a constant width.

In a further embodiment, the support plate comprises a glued-on damping plate covering both plate portions, and the adhesive layer between the damping plate and the plate portions viscoelastically supports the inner plate portion. The interspace between the plate portions can additionally receive the elastic or viscoelastic intermediate element.

For example, the intermediate element may be an elastomeric ring inserted into the slot.

In a further embodiment, an intermediate layer is arranged between the support plate and the friction lining, and the slot is filled with the intermediate layer material forming the elastic intermediate element.

According to another embodiment, three plate portions are provided, wherein the middle plate portion carrying the friction lining is connected via an elastic or viscoelastic intermediate element with the outer plate portions arranged in tangentially opposite relationship. This intermediate element may be formed by an elastomeric block connecting the plate portions.

Further, a damping plate covering all three plate portions may be glued to the support plate.

Hereunder embodiments of the invention are explained in detail with reference to the drawings in which:

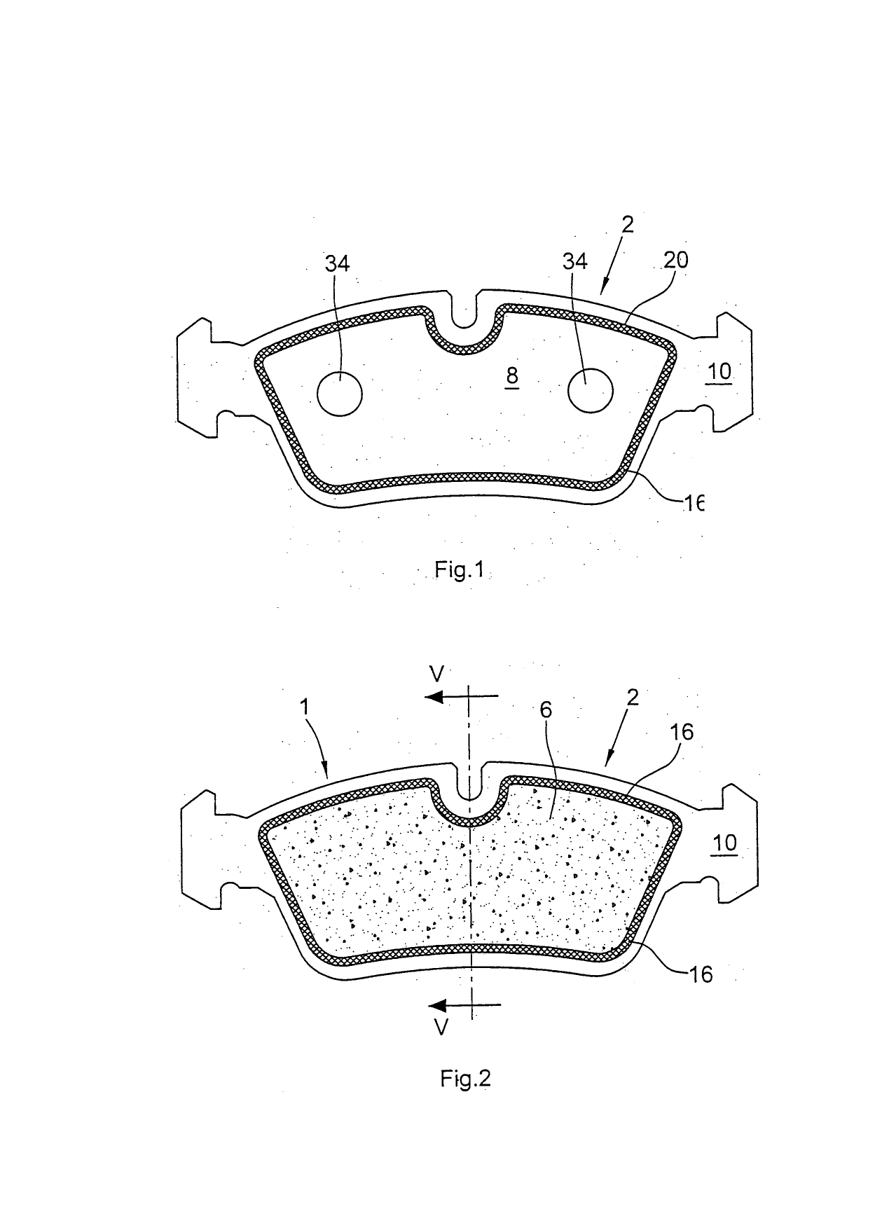

FIG. 1 shows a first embodiment of a support plate with separate plate portions.

FIG. 2 shows the embodiment of FIG. 1 with glued-on friction lining.

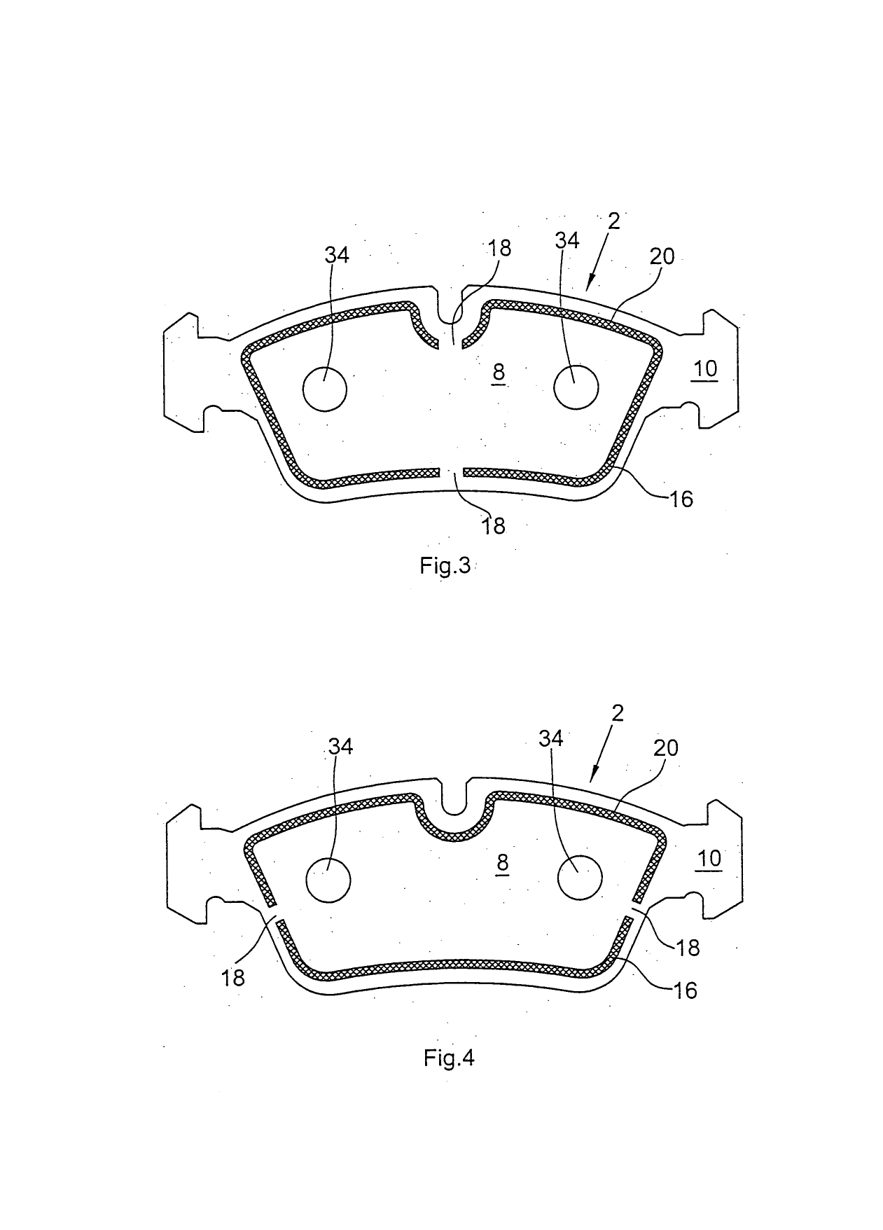

FIG. 3 shows a second embodiment according to FIG. 1 with webs arranged on a radial symmetry axis.

FIG. 4 shows an embodiment according to FIG. 1 with webs arranged on a tangential centerline.

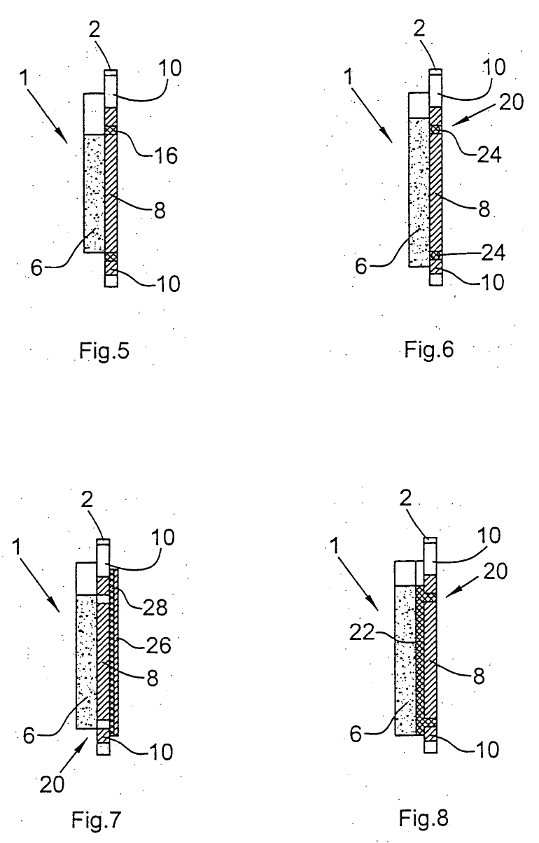

FIG. 5 shows a section along line V-V of FIG. 2.

FIG. 6 shows a sectional view of a further embodiment where the friction lining covers both plate portions.

FIG. 7 shows an embodiment with a damping plate.

FIG. 8 shows an embodiment with an intermediate layer.

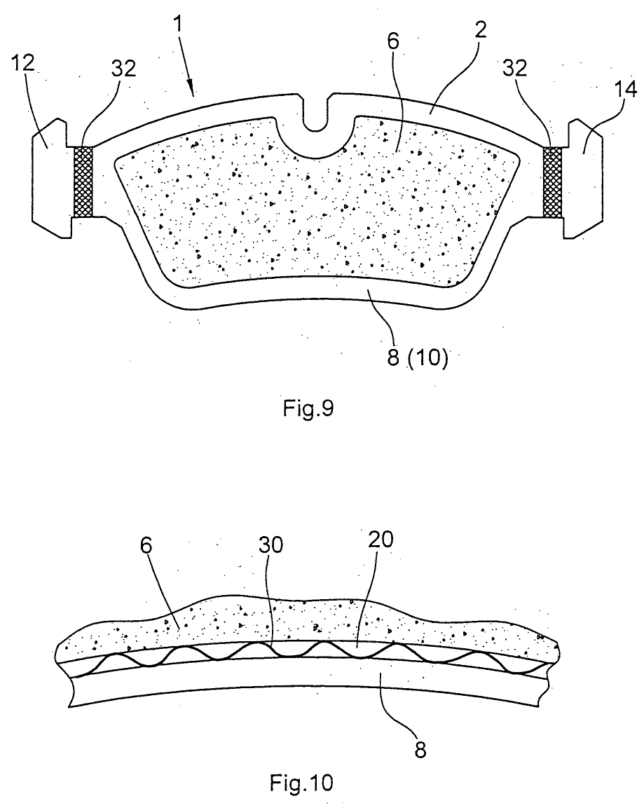

FIG. 9 shows a further embodiment with three plate portions.

FIG. 10 shows arrangement of a metallic spring element between the plate portions.

FIG. 1 shows a support plate 2 for a brake shoe in motor vehicle disk brakes. The support plate 2 is formed by two plate portions 8,10, wherein the outer plate portion 10 surrounds the inner plate portion 8. A slot of constant width separates the two plate portions. Said slot 20 may comprise an intermediate element 16 which elastically or viscoelastically connects the two plate portions 8,10. The support plate 2 is preferably made of metal but can also be made of a suitable plastic material which is fibre-reinforced, if necessary. It is further possible that the inner plate portion 8 and the outer plate portion 10 are made of different materials. In particular, the inner plate portion 8 can be made of plastic material and the outer plate portion 10 of metal.

FIG. 2 shows a brake shoe with a support plate according to FIG. 1 and a friction lining 6 glued to the inner plate portion 8.

FIG. 3 shows a preferred version of the support plate 2 which can be manufactured in one piece, wherein the two plate portions 8,10 are connected with each other via two webs 18 bridging the slot 20, said webs 18 being arranged on the radial symmetry axis of the brake shoe. In the slot 20 an intermediate element 16 may be disposed.

FIG. 4 shows an alternative embodiment where the webs 18 connecting the plate portions 8 and 10 are arranged on a tangential centerline of the brake shoe. The orientation of the webs determines the direction in which the inner plate portion can preferably oscillate.

While the embodiment shown in FIG. 3 preferably allows oscillations in tangential direction, the inner plate portion 8 according to FIG. 4 is more likely to oscillate in radial direction.

The embodiment shown in FIG. 3 is the preferred version. FIGS. 3 and 4 show embodiments where the inner plate portion 8 is connected via two webs 18 with the outer plate portion 10. It is to be noted that the inner plate portion 8 may also be connected via only one web 18 with the outer plate portion 10. Due to the one-piece configuration of the support plate 2 in the embodiments shown in FIGS. 3 and 4 the support plate 2 is made of one and the same material.

FIG. 5 shows a cross-section along line V-V of FIG. 2. In this embodiment, an intermediate element 16 is arranged in the slot 20, and the friction lining 6 is glued only to the inner plate portion 8. In contrast, in the embodiments shown in FIGS. 6 and 8 the friction lining 6 covers the two plate portions 8,10. Since in the embodiment shown in FIG. 6 the friction lining is also glued to the plate portion 10, an intermediate element 16 arranged in the slot 20 is not necessary. In the drawings, an elastomeric ring 24 is shown in the slot 20, said elastomeric ring 24 is however not absolutely necessary.

In the embodiment shown in FIG. 7 a damping plate 26, which is glued to the support plate 2 via an adhesive layer 28, connects the plate portions 8,10 thus providing the elastic or viscoelastic coupling of the two plate portions. The friction lining may be arranged only on the inner plate portion 8 as shown in FIG. 5, cover the slot 20 as shown in FIG. 7, or overlap both plate portions 8,10. Of course, the friction lining 6 is glued to the plate portion 10 only in a marginal area.

In a further alternative embodiment, the friction lining 6 partly covers the plate portion 10 but is not glued to the latter.

FIG. 8 shows an embodiment where an intermediate layer 22 is arranged between the friction lining and the support plate 2. In this embodiment, the intermediate layer 22 covers both plate portions 8,10 with intermediate layer material being further pressed into the slot 20 between the plate portions 8, 10.

Of course, the other embodiments shown in FIGS. 1 to 7 and 9 may also comprise an intermediate layer 22 without any intermediate layer material being necessarily provided in the slot 20.

FIG. 9 shows a further alternative embodiment where the support plate 2 is formed by a total of three plate portions 8,12,14. The friction lining 6 is glued to the middle plate portion 8. Two plate portions 12,14 extending mirror-symmetrically to the radial symmetry axis are connected via an elastic intermediate element, e.g. an elastomeric block 32, with the plate portion 8.

The embodiment shown in FIG. 9 may also be combined with the proposed solutions shown in FIGS. 1 to 8 and comprise a slot 20 with or without webs 18 and with or without intermediate elements 16 separating an inner plate portion 8 carrying the friction element 6 from an outer plate portion 10.

As in the embodiment shown in FIG. 7, the brake shoe shown in FIG. 9 as well as all other illustrated embodiments may be provided with a damping plate 26 covering all plate portions 8,12,14 and being connected with these via an adhesive layer 28.

FIG. 10 shows an embodiment according to FIGS. 1 to 8 where a metallic spring element 30 acting as the intermediate element 16 is provided in the slot 20 between the plate portions 6,8.

In all embodiments, the inner plate portion 8, which is set oscillating via the friction lining 6 during the braking process, is elastically or viscoelastically damped towards the outer plate portions 10,12,14 to realize a considerable reduction of the oscillations and vibrations and the resultant noise.

The plate portion 8 may be provided with holes 34 which can be filled with friction material when pressing the friction material of the friction lining 6 to achieve better anchoring of the friction lining 6 on the inner plate portion 8.

1. Brake shoe, in particular for a disk brake of motor vehicles, comprising a support plate (2) to which a friction lining (6) is fastened,
characterized in that
the support plate (2) is formed by a plurality of interconnected or separate plate portions (8,10;12,14), wherein at least one plate portion (8) carries the friction lining (6) which, relative to the at least on further plate portion (10; 12,14), is elastically or viscoelastically supported to prevent friction oscillations from occurring during the braking process.

2. Brake shoe according to claim 1, characterized in that the support plate (2) is formed by two plate portions (8,10) elastically or viscoelastically connected to each other.

3. Brake shoe according to claim 1, characterized in that two plate portions (8,10) are provided, wherein the inner plate portion (8) is surrounded by an outer plate portion (10).

4. Brake shoe according to claim 1, characterized in that the interconnected plate portions (8,10;12,14) are coupled to each other via at least one connecting web (18).

5. Brake shoe according to claim 4, characterized in that the at least one connecting web (18) is arranged on the radial centerline of the support plate (2).

6. Brake shoe according to claim 4, characterized in that the at least one connecting web (18) is arranged on a central tangential line of the support plate (2).

7. Brake shoe according to claim 3, characterized in that the friction lining (6) is exclusively connected with the inner plate portion (8).

8. Brake shoe according to claim 1, characterized in that the friction lining (6) is connected with both plate portions (8,10;12,14).

9. Brake shoe according to claim 3, characterized in that the inner and the outer plate portion (8,10;12,14) are connected with each other exclusively via the friction lining (6).

10. Brake shoe according to claim 1, characterized in that the plate portion (8) carrying the friction lining (6) is connected with the at least one further plate portion (10;12,14) via an elastic intermediate element (16).

11. Brake shoe according to claim 10, characterized in that the intermediate element (16) is made of an elastomeric material.

12. Brake shoe according to claim 10, characterized in that the intermediate element (16) is made of a friction material.

13. Brake shoe according to claim 10, characterized in that the intermediate element (16) is made of an intermediate layer material.

14. Brake shoe according to claim 10, characterized in that the intermediate element (16) is formed by at least one metallic spring element (30).

15. Brake shoe according to claim 3, characterized in that the inner plate portion (8) is separated from the outer plate portion (10) by a circumferential slot (20).

16. Brake shoe according to claim 3, characterized in that the support plate (2) comprises a glued-on damping plate (26) covering both plate portions (8,10), and the adhesive layer (28) between the damping plate (26) and the plate portions (8,10) elastically supports the inner plate portion (8).

17. Brake shoe according to claim 15, characterized in that the circumferential slot (20) receives the elastic or viscoelastic intermediate element (16).

18. Brake shoe according to claim 17, characterized in that the elastic intermediate element (16) is formed by an elastomeric ring (24) inserted in the slot (20).

19. Brake shoe according to claim 17, characterized in that between the support plate (2) and the friction lining (6) an intermediate layer (22) is arranged, and the slot (20) is filled with the intermediate layer materials forming the elastic intermediate element (16).

20. Brake shoe according to claim 1, characterized in that three plate portions (8,12,14) are provided, and the middle plate portion (8) carrying the friction lining is connected via an elastic or viscoelastic intermediate element (16) with two outer plate portions (12,14) arranged in tangentially opposite relationship.

21. Brake shoe according to claim 1, characterized in that four plate portions (8,10;12,14) are provided, wherein an inner plate portion (8) carrying the friction lining (6) is elastically or viscoelastically connected with an outer plate portion (10) surrounding the inner plate portion (8), and the outer plate portion (10) is connected via an elastic or viscoelastic intermediate element (16) with two plate portions (12,14) projecting in tangential direction.

22. Brake shoe according to claim 20, characterized in that the elastic intermediate element (16) is formed by an elastomeric block (32) connecting the plate portions (8,10;12,14).

23. Brake shoe according to claim 20, characterized in that a damping plate (26) covering all plate portions is glued to the support plate (2).

24. Brake shoe according to claim 16, characterized in that the circumferential slot (20) receives the elastic or viscoelastic intermediate element (16).

25. Brake shoe according to claim 21, characterized in that the elastic intermediate element (16) is formed by an elastomeric block (32) connecting the plate portions (8,10;12,14).
